(19) United States
(12) Patent Application Publication
(10) Pub. No.: US 2016/0142493 A1
(43) Pub. Date: May 19, 2016

(54) SENSOR DATA COLLECTION SYSTEM

(71) Applicant: HITACHI SOLUTIONS, LTD., Tokyo (JP)

(72) Inventors: Akira MORIGUCHI, Tokyo (JP); Noriko TAKADA, Tokyo (JP); Kenji OOKURA, Tokyo (JP); Yuichi NAKAMURA, Tokyo (JP); Tomoki YADA, Tokyo (JP)

(21) Appl. No.: 14/898,151

(22) PCT Filed: May 14, 2014
(86) PCT No.: PCT/JP2014/062843

§ 371 Date: Dec. 14, 2015

(30) Foreign Application Priority Data
Jul. 31, 2013 (JP) 2013-158495

(51) Int. Cl. H04L 29/08; H04L 12/24

(52) U.S. Cl. CPC H04L 67/12; H04L 41/0803

(57) ABSTRACT

The sensor data collection system includes one or a plurality of sensors; a gateway device capable of collecting, converting, processing, making a threshold determination of, and compressing data from the sensors and transmitting the data to a data collection server at a timing set as needed; and the data collection server that collects the sensor data from the gateway device. The data collection server includes a means that compresses sensor data conversion, processing, threshold determination, compression, and transmission timing settings into a binary and transmits the binary to the gateway device. The gateway device includes a means that executes conversion, processing, threshold determination, and compression with respect to the data collected from the sensors in accordance with the various settings compressed into the binary, and that transmits the sensor data to the data collection server at the set transmission timing.

### TECHNICAL FIELD

The present invention relates to a sensor data collection system comprising a sensor, a gateway device, and a data collection server.

### BACKGROUND ART

In recent years, there have been growing needs in various industrial fields for collecting and analyzing data from sensors attached to devices and infrastructures for autonomous machine control and failure prediction.

For example, there is the need for collecting data from a temperature sensor and a load sensor attached to a vehicle engine and analyzing component loads in the vehicle so as to predict the timing of component replacement.

In order to analyze sensor data and establish a data utilization method for failure prediction, for example, it is necessary to decrease the load of a server collecting data from a large number of sensors and the amount of data communication. For this purpose, a gateway device positioned between the sensors and the server is required to perform data filtering, processing, and compression.

In order to increase the accuracy of data analysis, it is also necessary to employ a cycle of hypothesis testing, including making a hypothesis as to the data to be collected and their utilization method; collecting the data; performing statistical analysis and verification; modifying the hypothesis on the basis of the verification result; and again collecting data. Accordingly, the methods of filtering and processing the data on the gateway device need to be capable of being dynamically updated.

Patent Literature 1 indicated below discloses a system in which the sensor data transmitted in various forms are converted into a unified format on the gateway on the basis of a conversion rule delivered from the server, so as to limit new addition or the cost of extension of applications that utilize the sensor data.

Patent Literature 2 indicated below discloses a system in which traffic information collected from sensors in a plurality of vehicles is tallied among the vehicles using vehicle-to-vehicle communication and then transmitted to the server, so as to decrease the server load and communication volume.

### CITATION LIST

### Patent Literature

Patent Literature 1: JP Patent Publication (Kokai) 2012-164369 A
Patent Literature 2: JP Patent Publication (Kokai) 2007-310733 A

### SUMMARY OF INVENTION

### Technical Problem

However, in order to implement efficient collection of sensor data, it is not sufficient, as a gateway function, to be able to merely convert and process the collected sensor data as described in Patent Literature 1. Other functions necessary include an abnormality detection function of transmitting an alert immediately to the server upon detection of an abnormal value; a communication volume reduction function of compressing multiple sensor data; and a function of defining the transmission timing, such as a regular time interval or specific position.

Without the abnormality detection function, high-emergency sensor data cannot be collected in real-time.

Without the data compression function, the communication volume reduction effect will be limited. Further, if the transmission timing cannot be defined, the large volume of communication load from the gateway to the server cannot be distributed. Thus, the gateway needs to be capable of setting the sensor data conversion, processing, abnormaly detection, compression, and transmission timing all together.

The gateway may be a small-resource device. In this case, the setting information may exceed the device's memory or storage capacity if there are a large number of rules that are set.

In the system described in Patent Literature 2, each vehicle needs to be equipped with an in-vehicle communication device capable of performing vehicle-to-vehicle communication according to a common protocol. As a result, the utilization scenes are limited.

An object of the present invention is to provide a sensor data collection system such that data collection server load and communication volume can be decreased; real-time data collection is enabled with regard to high-emergency data while achieving a reduction in communication volume; the definitions of rules describing the methods of sensor data conversion, processing, threshold determination, compression, and transmission timing can be dynamically updated from the data collection server so as to ensure real-time collection of high-emergency data; and the rule definitions can be implemented even when the gateway device is a small-resource device.

### Solution to Problem

In order to achieve the object, the present invention includes one or a plurality of sensors; a gateway device capable of collecting, converting, processing, making a threshold determination of, and compressing data from the sensors and transmitting the data to a data collection server at a timing set as needed; and the data collection server that collects the sensor data from the gateway device. The data collection server includes a means that compresses sensor data conversion, processing, threshold determination, compression, and transmission timing settings into a binary and that transmits the binary to the gateway device. The gateway device includes a means that executes conversion, processing, threshold determination, and compression with respect to the data collected from the sensors in accordance with the various settings compressed into the binary, and that transmits the sensor data to the data collection server at the set transmission timing.

### Advantageous Effects of Invention

According to the present invention, rule definitions for sensor data conversion, processing, threshold determination, compression, and transmission timing can be set even in a small-resource gateway device via a wide area network, whereby high-emergency data can be collected in real-time while achieving a decrease in the load and communication volume of the data collection server that collects the sensor data.

### BRIEF DESCRIPTION OF DRAWINGS

FIG. 1 is a configuration diagram of a rule definition updating-type sensor data collection system according to an embodiment of the present invention.

FIG. 2 is a diagram of an example of conversion rule definitions.

FIG. 3 is a diagram of an example of processing rule definitions.

FIG. 4 is a diagram of an example of pre-processing threshold value rule definitions.

FIG. 5 is a diagram of an example of post-processing threshold value rule definitions.

FIG. 6 is a diagram of an example of transmission timing definitions.

FIG. 7 is a diagram of an example of transmission content definitions.

FIG. 8 is a diagram for describing a configuration of binary definition table groups.

FIG. 9 is a diagram of an example of a conversion rule binary configuration table.

FIG. 10 is a diagram of an example of a data class bit string table.

FIG. 11 is a diagram of an example of a byte order bit string table.

FIG. 12 is a diagram of an example of a data type bit string table.

FIG. 13 is a diagram of an example of a conversion method bit string table.

FIG. 14 is a diagram of an example of a latest value cache.

FIG. 15 is a diagram of an example of a processing data cache.

FIG. 16 is a diagram of an example of a data storage unit.

FIG. 17 is a sequence diagram of a rule definition generation/delivery process.

FIG. 18 is a flowchart of a rule binary generation process.

FIG. 19 is a diagram of an example of a conversion rule binary.

FIG. 20 is a sequence of a sensor data processing/transmission process.

FIG. 21 is a flowchart of a data conversion process.

FIG. 22 is a flowchart of a data processing process.

FIG. 23 is a flowchart of a pre-processing threshold determination process.

FIG. 24 is a flowchart of a post-processing threshold determination process.

FIG. 25 is a flowchart of a data transmission process.

FIG. 26 is a diagram of an example of transmission data.

FIG. 27 is a flowchart of a data reception process.

FIG. 28 is a flowchart of a sensor data processing/transmission process at the time of processing rule updating.

### DESCRIPTION OF EMBODIMENTS

In the following, embodiments of the present invention will be described with reference to the drawings.

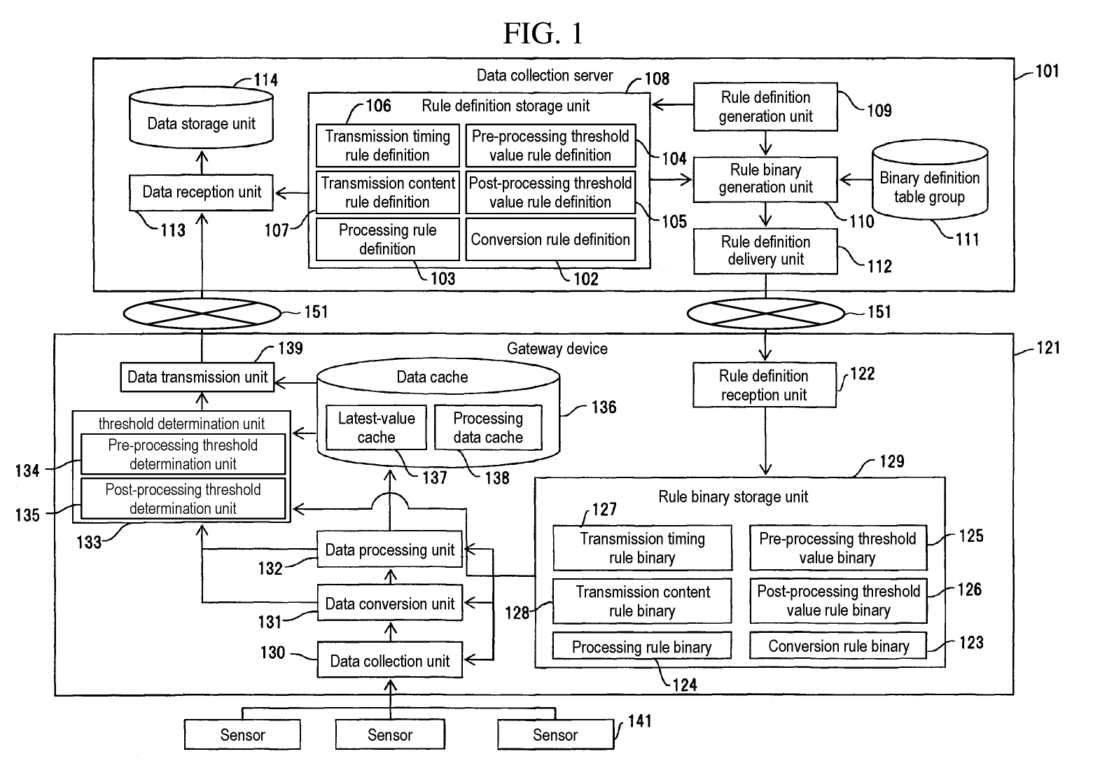

FIG. 1 is a system configuration diagram of an embodiment of a sensor data collection system according to the present invention.

The sensor data collection system according to the present embodiment generally comprises a data collection server 101, a gateway device 121, and a plurality of sensors 141.

The collection server 101 and the gateway device 121 are connected by a wide area network 151, such as the Internet. The gateway device 121 and the sensors 141 are connected by a local network, such as CAN (Controller Area Network), Zigbee (registered trademark of Zigbee Alliance), or Wi-Fi (registered trademark of Wi-Fi Alliance).

For example, in the case of in-vehicle sensors, the gateway device 121 and the sensors 141 are connected by CAN, whereby data such as engine load and brake state can be collected from the gateway device 121 and sent to the data collection server 101 for vehicle failure sign diagnosis and the like.

The data collection server 101 is a server that collects and manages sensor data, and includes a rule definition generation unit 109, a rule binary generation unit 110, a rule definition delivery unit 112, a rule definition storage unit 108, a binary definition table group 111, a data reception unit 113, and a data storage unit 114.

The rule definition generation unit 109, in response to an input from an administrator of the data collection server 101 via a UI (User Interface), stores, in the rule definition storage unit 108, a conversion method and processing method for the sensor data of the gateway device 121; a processed data transmission method and transmission timing; and threshold values for determining the possibility of immediate data transmission, as a conversion rule definition 102; a processing rule definition 103; a transmission content rule definition 107; a transmission timing rule definition 106; a pre-processing threshold value rule definition 104; and a post-processing threshold value rule definition 105.

The pre-processing threshold value rule definition 104 and the post-processing threshold value rule definition 105 are prepared for performing both threshold determination for the collected data and threshold determination for the data after a statistical process, such as histogram generation. For example, in the case of engine coolant temperature, an abnormal value may be immediately recognized if the temperature is 90° C. or above. Alternatively, an abnormal value may be recognized if the number of times of detection of values of 70° C. or above among data collected in a day is a certain number or more. In the server-side rule definition storage unit 108, various rule definitions are stored in format such as XML (Extensible Markup Language) or tables.

The rule binary generation unit 110, in order to enable the storage of the rule definitions even when the gateway device 121 has small resources, reads the various rule definitions from the server-side rule definition storage unit 108, and converts the rule definitions into rule binaries in accordance with binary conversion rules set in the binary definition table group 111.

The rule definition delivery unit 112 delivers the rule binaries received from the rule binary generation unit 110 to the gateway device 121.

The data reception unit 113 breaks up the data received from the gateway device 121 in accordance with the transmission content rule definition 107, and stores the data in the data storage unit 114.

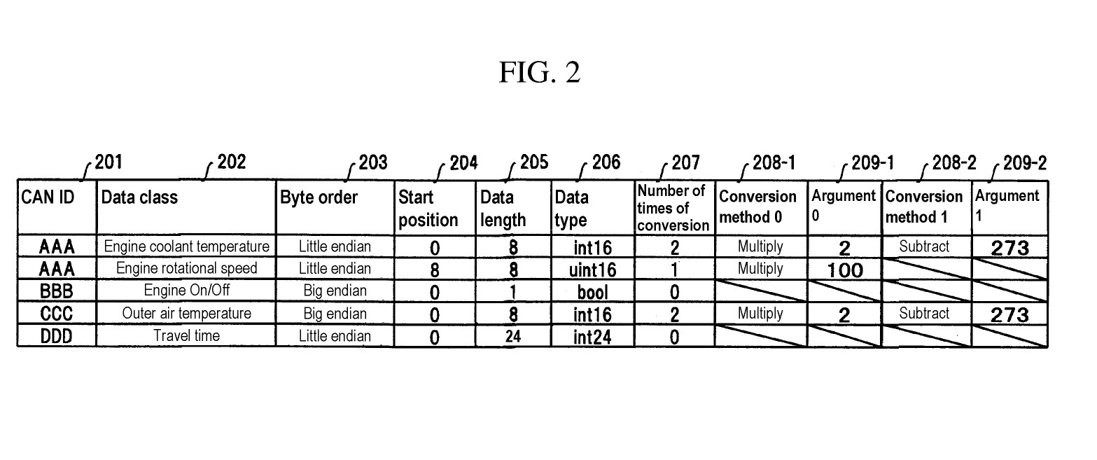

An example of the conversion rule definition 102 is illustrated in FIG. 2. CAN ID 201 (Identifier) is an ID (identification information) for uniquely indicating the sensor data flowing in the CAN. An ID that uniquely indicates sensor data is similarly entered in the case of a network other than CAN. For example, in the case of Zigbee, IDs provided to the sensors are entered. A data class 202 indicates the semantics of sensor data, such as engine coolant temperature and engine rotational speed. While the CAN ID 201 “AAA” shown by way of example is tied to two pieces of data engine coolant temperature and engine rotational speed, this is because in a CAN, one packet of data provided with a single CAN ID 201 may include a plurality of pieces of data. In addition, there are stored a byte order bit string 1101 of sensor data; a start position 204 and data length 205 of target data in a received packet; a data type 206 in a programming language on the gateway device 121; the number of times of conversion 207; a conversion method 208; and a conversion process argument 209. In a sensor network such as CAN, for the purpose of data size reduction, the value of data to be transmitted may be divided before transmission, or a value represented by a different unit system may be transmitted.

In the case of FIG. 2, the engine coolant temperature is expressed by an absolute temperature which is further divided by “5” for reducing the number of digits before transmission. Accordingly, multiplication by “5” and subtraction of “273” are necessary.

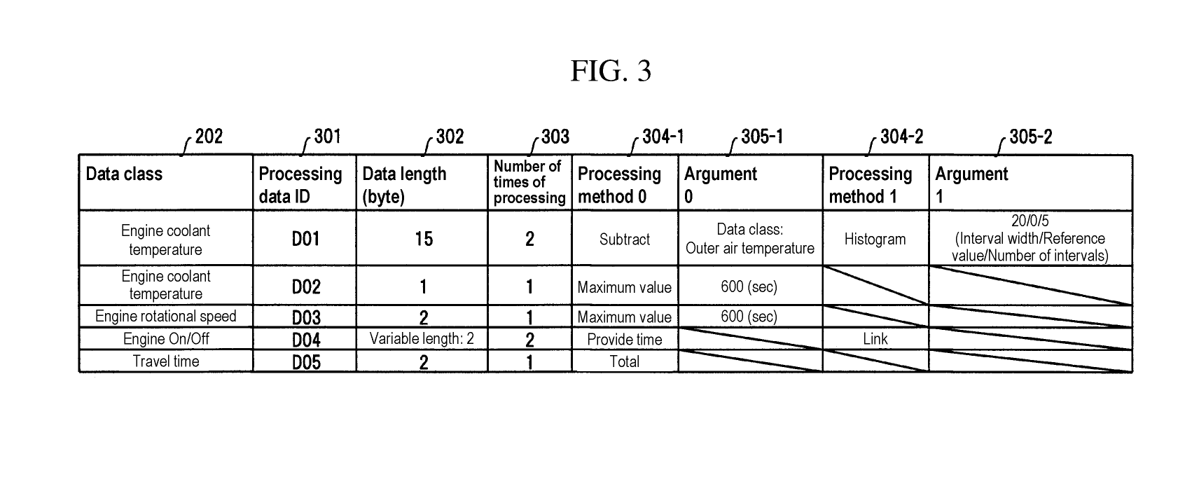

An example of the processing rule definition 103 is illustrated in FIG. 3. In the processing rule definition 103, there are stored the data class 202; a processing data ID 301 for uniquely identifying processed data; a data length 302 of processing data; the number of times of processing 303; a processing method 304; and a processing process argument 305.

As in the engine coolant temperature of FIG. 3, a plurality of processing processes may be performed for the sensor data of a single data class 202. In the processing process for the processing data “D01”, with respect to an acquired engine coolant temperature, the outer air temperature acquired from another sensor 141 is subtracted, and then a histogram is generated.

In the processing process for the processing data “D02”, a maximum value of the engine coolant temperature in a period of 600 seconds is determined. In the case of the processing data “D04”, the acquired On/Off data are provided with an acquisition time, and the data after the time provision is linked with processed data that have previously been acquired.

In the case of the processing data “D05”, a total value of an acquired travel time and a travel time that has previously been acquired is determined. When variable data have a variable length, the data length 302 is provided with a character string indicating the variable length as a header and the number of bytes indicating the data length, as in “variable length: 2”.

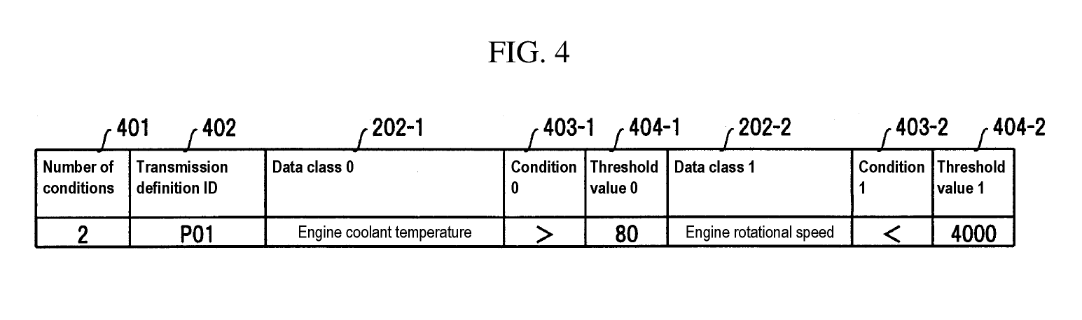

An example of the pre-processing threshold value rule definition 104 is illustrated in FIG. 4.

In the pre-processing threshold value rule definition 104, there are stored the number of threshold determination conditions 401; a transmission definition ID 402 uniquely indicating a transmission method in case a threshold value is exceeded; the data class 202; a threshold determination condition 403; and a threshold value 404. In the illustrated example, the definition is such that if the acquired engine coolant temperature is greater than the threshold value “80” (condition), and if the engine rotational speed is smaller than the threshold value “4000” (condition), data is transmitted by the data transmission process.

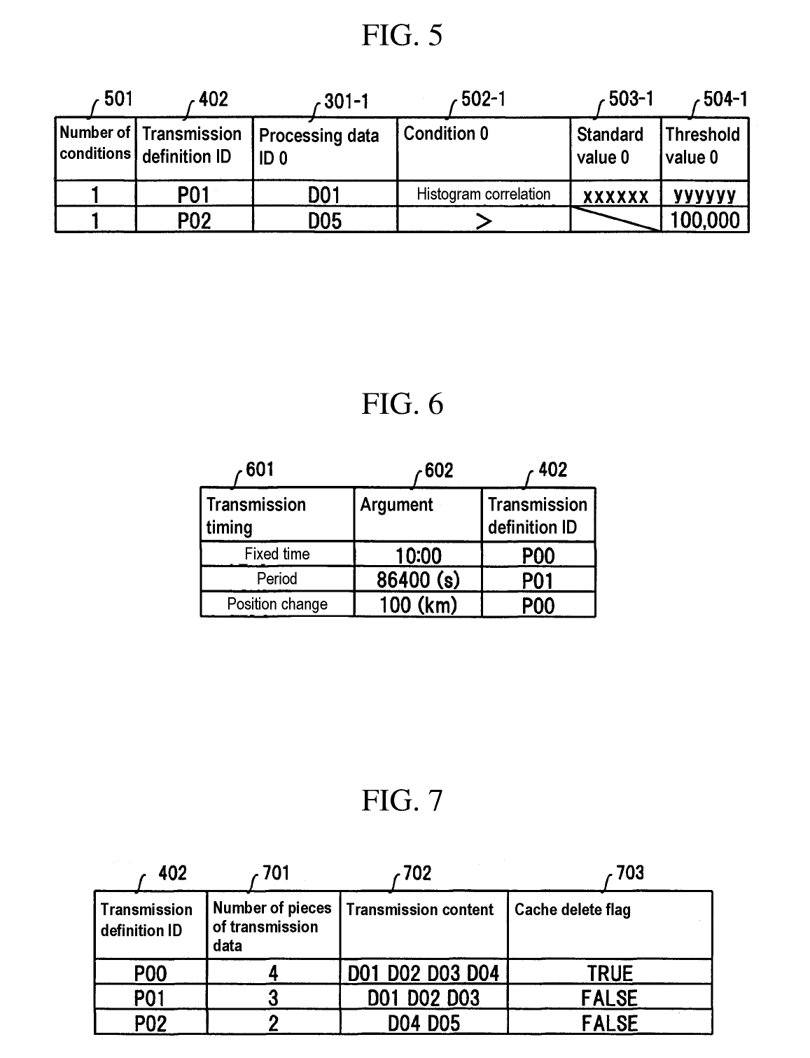

An example of the post-processing threshold value rule definition 105 is illustrated in FIG. 5. In the post-processing threshold value rule definition 105, there are stored the number of threshold determination conditions 501; the transmission definition ID 402 indicating a transmission method in case a threshold value is exceeded; the processing data ID 301; a threshold determination condition 502; a standard value 503; and a threshold value 504. The standard value 503 is used for comparison with processing data in the threshold determination method described in the condition 502. For example, when the condition 502 is histogram correlation, a normal histogram is stored in the standard value 503 and utilized for comparison with processing data.

An example of the transmission timing rule definition 106 is illustrated in FIG. 6.

In the transmission timing rule definition 106, there are stored a transmission timing 601, a transmission timing argument 602, and the transmission definition ID 402 defining the data to be transmitted upon reaching the timing described in the transmission timing 601. For example, when the transmission timing 601 is a fixed time, data transmission is performed at the time described in the argument 602 (at 10 o'clock in the illustrated example). When the transmission timing 601 is a period, data transmission is performed each time the time described in the argument 602 elapses (after the elapse of 86400 seconds in the illustrate example). When the transmission timing 601 is a position change, data transmission is performed each time the distance described in the argument 602 (100 Km in the illustrated example) is travelled.

An example of the transmission content rule definition 107 is illustrated in FIG. 7.

In the transmission content rule definition 107, there are stored the transmission definition ID 402; the number of pieces of transmission data 701; a transmission content 702 designating the processing data 1501 to be transmitted; and a cache delete flag 703 indicating whether the processing data 1501 is to be deleted at the time of transmission.

For example, when the transmission definition ID 402 is “P00”, the gateway device 121 links the processing data 1501 of the processing data ID 301 “D01”, “D02”, “D03”, and “D04”, transmits the data to the data collection server 101, and then deletes the transmitted processing data from storage.

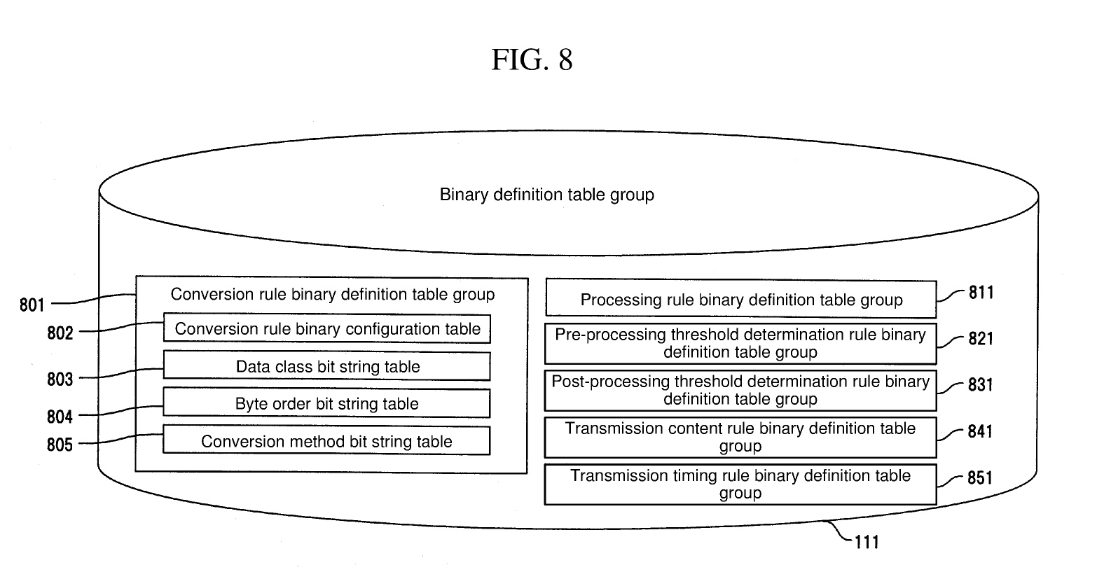

A configuration of the binary definition table group 111 is illustrated in FIG. 8.

The binary definition table group 111 includes tables defining bit string configurations for converting the rule definitions into rule binaries, and comprises a conversion rule binary definition table group 801; a processing rule binary definition table group 811; a pre-processing threshold determination rule binary definition table group 821; a post-processing threshold determination rule binary definition table group 831; a transmission content rule binary definition table group 841; and a transmission timing rule binary definition table group 851.

The conversion rule binary definition table group 801 comprises a conversion rule binary configuration table 802 defining a bit string arrangement of a conversion rule binary 123, and a data class bit string table 803, a byte order bit string table 804, and a conversion method bit string table 805 for converting the items of the conversion rule definition 102 into bit strings.

When a value in the conversion rule definition 102 may be converted as is into a bit string, such as the CAN ID 201 or the start position 204, the bit string tables may not be created. While not described in FIG. 8, the other binary definition table groups 111 also include a table defining the rule binary bit string arrangement and tables for converting the items in the rule definition into bit strings, similarly to the conversion rule binary definition table group 801.

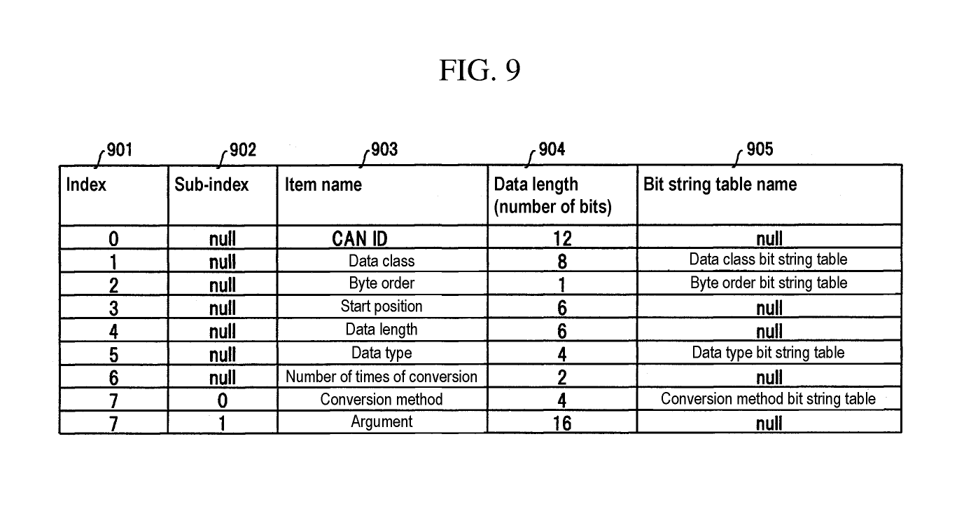

An example of the conversion rule binary configuration table 802 is illustrated in FIG. 9.

The conversion rule binary configuration table 802 has an index 901 indicating the order of arrangement of an item in the binary; a sub-index 902 indicating the order of a plurality of items, if any, such as the conversion method 208 and the argument 209; an item name 903 in the conversion rule definition 102; a data length 904; and a bit string table name 905 designating the bit string conversion method 208.

The items of the conversion rule definition 102 are respectively converted into bit strings of the data length 904 and linked in the order designated by the index 901 and the sub-index 902.

The data class bit string table 803 is illustrated in FIG. 10.

The data class bit string table 803 comprises the data class 202 and a data class bit string 1001. The rule binary generation unit 110 converts the data class 202 into a bit string in accordance with the table.

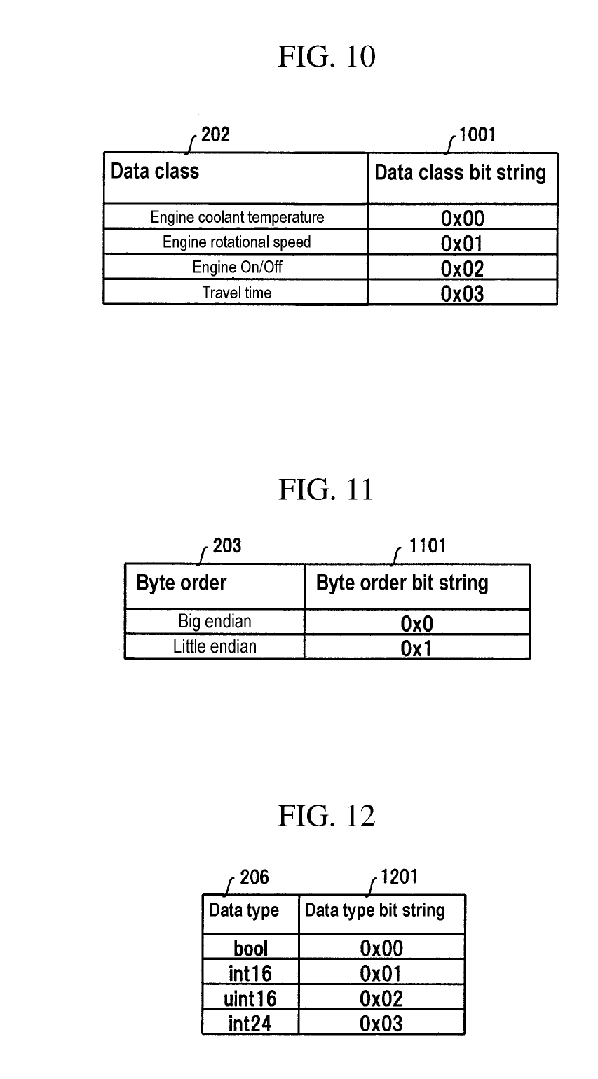

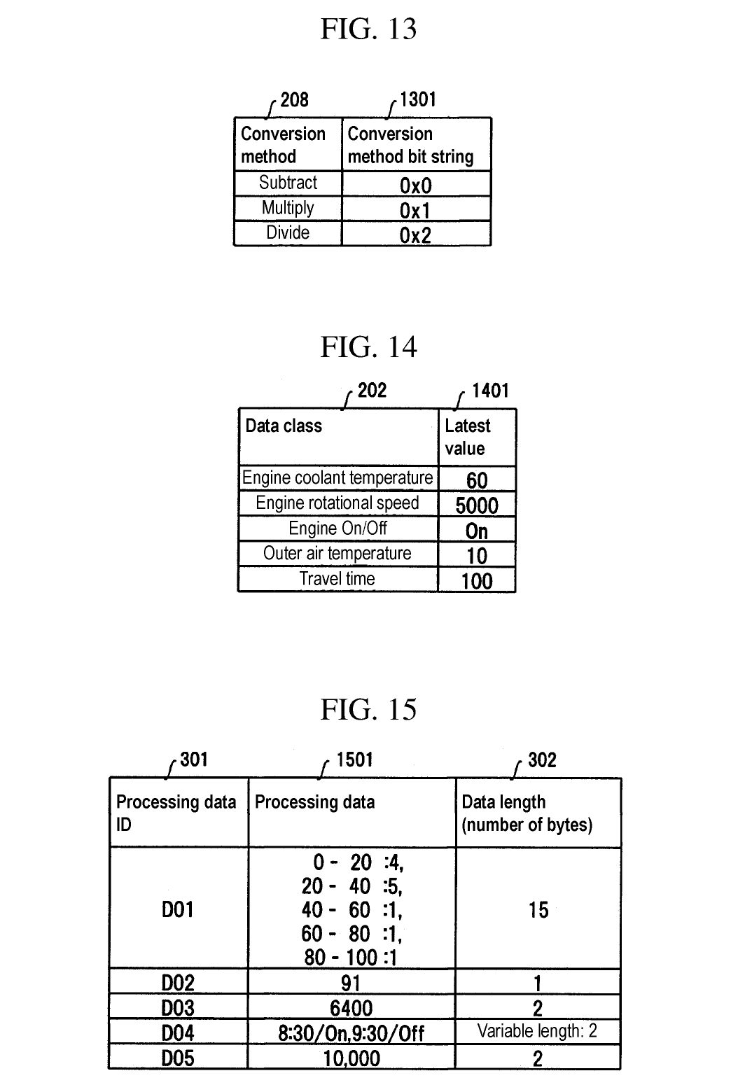

Examples of the other tables including the byte order bit string table 804, the data type bit string 1201 table, and the conversion method bit string table 805 are respectively illustrated in FIG. 11, FIG. 12, and FIG. 13.

As in the case of the data class bit string table 803, the rule binary generation unit 110 converts the items of the conversion rule definition 102 into bit strings.

The gateway device 121 is a device that converts and processes the data collected from the sensors 141, and then transmits the processed data to the data collection server 101. The gateway device 121 comprises a rule definition reception unit 122; a rule binary storage unit 129; a data collection unit 130; a data conversion unit 131; a data processing unit 132; a threshold determination unit 133; a data transmission unit 139; and a data cache 136.

The rule definition reception unit 122 stores various rule binaries received from the data collection server 101 in the rule binary storage unit 129.

In the rule binary storage unit 129, there are stored the conversion rule binary 123; a processing rule binary 124; a pre-processing threshold value rule binary 125; a post-processing threshold value rule binary 126; a transmission timing rule binary 127; and a transmission content rule binary 128, respectively corresponding to the conversion rule definition 102; the processing rule definition 103; the pre-processing threshold value rule definition 104; the post-processing threshold value rule definition 105; the transmission timing rule definition 106; and the transmission content rule definition 107, individually binary-converted by the rule binary generation unit 110.

The data collection unit 130 sends the data collected from the sensors 141 to the data conversion unit 131.

The data conversion unit 131 converts the values included in the sensor data received from the data collection unit 130 into general-purpose values in accordance with the conversion rule binary 123 and stores the converted values in the data cache 136, and notifies the data processing unit 132 and the threshold determination unit 133. If there is no corresponding conversion rule binary 123, the sensor data is discarded as unwanted data.

The data processing unit 132, after receiving the notification from the data conversion unit 131, acquires data from the data cache 136. The data processing unit 132 processes the acquired data in accordance with the processing rule binary 124 together with the existing processing data 1501 stored in the data cache 136, performs processing processes such as histogram generation and maximum value determination, and then stores a value in the data cache 136 again.

The threshold determination unit 133 includes a pre-processing threshold determination unit 134 and a post-processing threshold determination unit 135. The pre-processing threshold determination unit 134, after receiving the notification from the data conversion unit 131, determines whether the data acquired from the data cache 136 exceeds a threshold value in accordance with the pre-processing threshold value rule binary 125.

If the pre-processing threshold value rule binary 125 is generated from the pre-processing threshold value rule definition 104 shown in FIG. 4 and if there is a plurality of data classes 202 necessary for threshold determination, threshold determination is performed by acquiring the corresponding latest value 1401 from the data cache 136.

The post-processing threshold determination unit 135 determines whether the processing data 1501 acquired from the data processing unit 132 exceeds a threshold value in accordance with the post-processing threshold value rule binary 126. In the post-processing threshold determination as well as in the pre-processing threshold determination, if there is a plurality of pieces of processing data 1501 necessary for threshold determination, threshold determination is performed by acquiring the corresponding processing data 1501 from the data cache 136.

In each case, if a threshold value excess is found, the threshold determination unit 133 requests the data transmission unit 139 for data transmission.

The data transmission unit 139 monitors the transmission timing 601 in accordance with the transmission timing rule binary 127, and transmits the processing data 1501 to the data collection server 101 upon reaching the transmission timing 601.

The data cache 136 comprises a latest value cache 137 in which a latest value 1401 is stored, and a processing data cache 138 in which the processing data 1501 are stored.

An example of the latest value cache 137 is illustrated in FIG. 14.

In the latest value cache 137, the data class 202 and its latest value 1401 are stored. The latest value 1401 of the corresponding data class 202 is updated each time the data processing unit 132 receives data.

An example of the processing data cache 138 is illustrated in FIG. 15.

In the processing data cache 138, the processing data ID 301, the processing data 1501, and the data length 302 are stored. Reading and updating are performed each time the data processing unit 132 receives data.

For example, for the processing data ID 301 “D01”, subtraction by outer air temperature and histogram are set as the processing method 304 in the data processing rule definition 103, and as the argument 305 of the histogram, “20/0” is set, indicating the interval 20 and a reference value 0. Accordingly, histogram tallying values obtained by subtracting the outer air temperature from the engine coolant temperature at 20° C. intervals from the value 0 are stored.

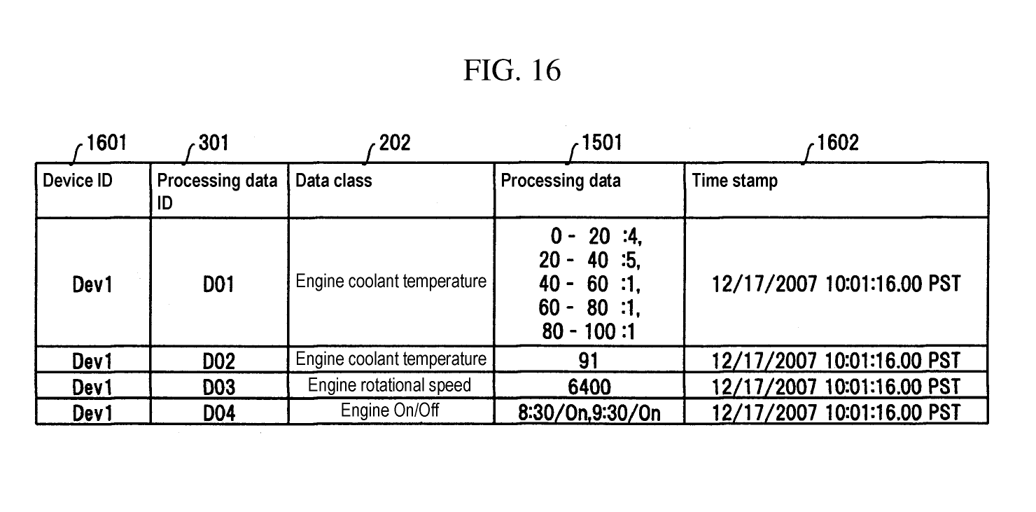

An example of the data storage unit 114 is illustrated in FIG. 16.

In the data storage unit 114, data collected from the gateway device 121 including the processing data ID 301, the data class 202, the processing data 1501, and a time stamp 1602 indicating the time of collection of the data are stored and utilized for device state visualization or statistical analysis.

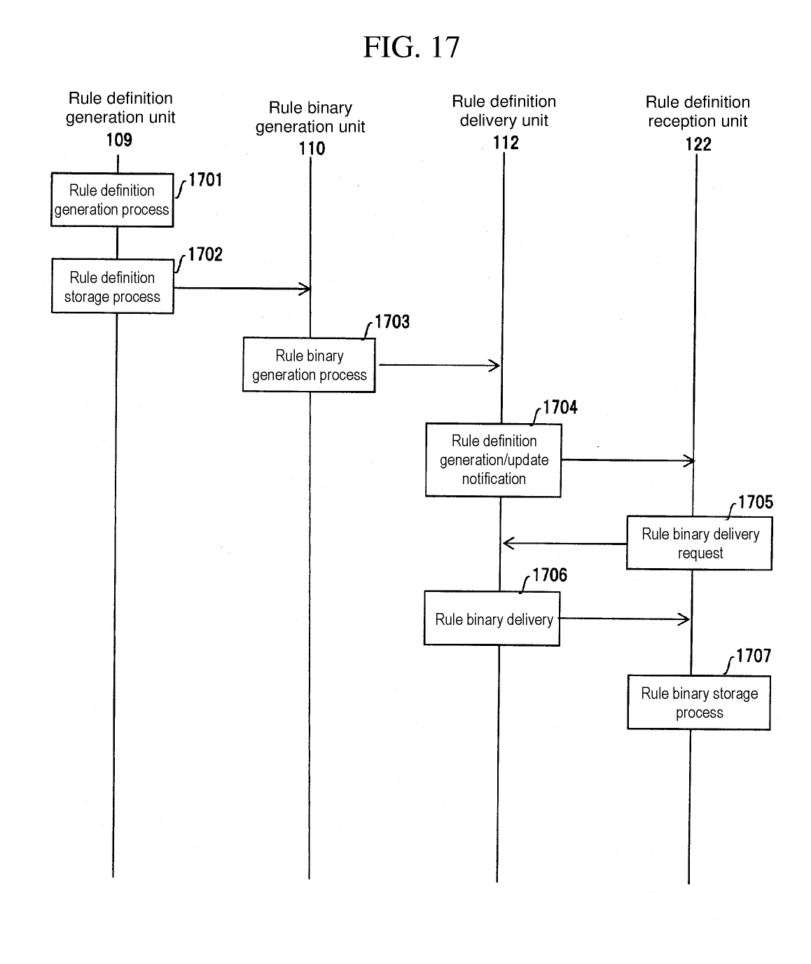

A sequence describing a rule definition generation/delivery process is illustrated in FIG. 17.

The rule definition generation unit 109, in response to an input from the UI, generates a rule definition. If there already is a rule definition, the rule definition is updated (step 1701).

The rule definition generation unit 109 stores the rule definition generated in step 1701 in the rule definition storage unit 108, and outputs a rule binary generation request to the rule binary generation unit 110 (step 1702).

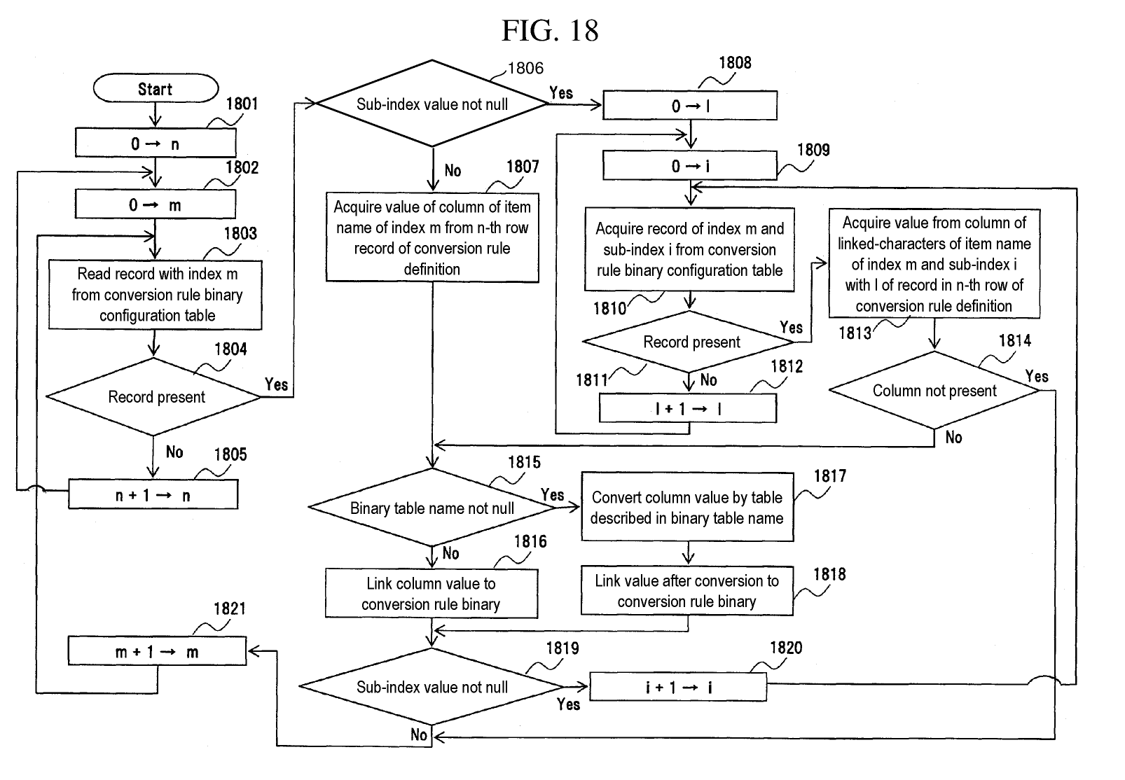

The rule binary generation unit 110 acquires the rule definition stored in step 1702, converts the rule definition into a rule binary on the basis of the binary conversion method 208 described in the definition table group 111, and outputs a rule definition delivery request to the rule definition delivery unit 112 (step 1703). The conversion process for the rule definition into the rule binary will be described in detail with reference to FIG. 18.

The rule definition delivery unit 112 outputs a rule definition generation/update notification to the rule definition reception unit 122 (step 1704). The notification is made via SMS or LongPolling. This step is for reflecting the generated rule definition in the gateway device 121 immediately, and may be eliminated if immediacy is not required.

The rule definition reception unit 122 outputs a rule binary delivery request to the rule definition delivery unit 112 (step 1705).

The rule definition delivery unit 112 transmits the rule binary generated in step 1703 to the rule definition reception unit 122 (step 1706).

The rule definition reception unit 122 stores the rule binary received in step 1706 in the rule binary storage unit 129 (step 1707).

FIG. 18 shows a flowchart of the process of generating the conversion rule binary 123 in step 1703. Processes similar to the flowchart are also performed for the other rule binaries.

First, 0 is stored in the variable n, which indicates the row of the conversion rule definition 102 during the binary generation process. The number is incremented in step 1805 which will be described below, and the rule binary generation process is repeated until the final row of the conversion rule definition 102 (step 1801).

Then, 0 is stored in the variable m, which corresponds to the index 901 in the conversion rule binary configuration table 802 and indicates the items of the conversion rule definition 102 during the conversion process. The number is incremented in step 1821 which will be described later, and the rule binary generation process is performed for all of the items of the conversion rule definition 102 (step 1802).

Thereafter, a record with the index 901 m is read from the conversion rule binary configuration table 802. In the case of FIG. 9, when m is 0, the record with the item name 903 “CAN ID 201” is read (step 1803).

If there is the record in step 1803, the process proceeds to step 1806; if not, the process proceeds to step 1805. In the example of FIG. 9, there are records when m is 0 to 7, so that the process proceeds to step 1806. When m is 8, the process transitions to the rule binary generation for the next row of the conversion rule definition 102 (step 1804).

Then, n is incremented and the process returns to step 1802 (step 1805).

If the sub-index 902 of the record acquired in step 1803 is null, the process proceeds to step 1807. If there is a value stored in the sub-index 901, the process of step 1808 and the subsequent steps is performed assuming that there is a plurality of items in one record.

In the example of FIG. 9, when m is 0 to 6, the sub-index 902 is null, indicating that the items designated by the item name 903 appears only once in the conversion rule definition 102. When m is 7, values are stored in the sub-index 902, indicating that the items “conversion method 208” and “argument 209” appear a plurality of times in the conversion rule definition 102 (step 1806).

From the record in the n-th row of the conversion rule definition 102, the value of the same column name as the item name 903 of the conversion rule binary configuration table 802 that was acquired in step 1803 is acquired. For example, when n=0 and m=0, from the 0th row record of the conversion rule definition 102 of FIG. 2, “AAA” is acquired, which is the value of the column of the item name 903 “CAN ID 201” of the index 901 0 in the conversion rule binary configuration table 802 of FIG. 9 (step 1807).

Zero is stored in the variable 1, which is a value indicating the order of the items that appear a plurality of times in the conversion rule definition 102. The value is incremented in step 1812, and the process of step 1809 to step 1820 is repeated for the number of times that the items appear (step 1808).

Zero is stored in variable i, which is a value indicating the value of the sub-index 902 of the conversion rule binary configuration table 802 as the object of the conversion rule binary 123 generation process. The value is incremented in step 1820, and the process of step 1810 to step 1819 is repeated for the number of the items that appear a plurality of times (step 1809).

Then, the record of the index 901 m and the sub-index 902 i is acquired from the conversion rule binary configuration table 802 (step 1810).

In step 1810, if there is the record, the process proceeds to step 1813; if not, the process advances to step 1814. For example, when m=7 and i=0, there is the record of the index 901 “7” and the sub-index 902 “0” in the conversion rule binary configuration table 802 in step 1809, so that the process proceeds to step 1813. When m=6 and i=0, there is no record as the object in the conversion rule binary configuration table 802, so that the process advances to step 1812.

The variable 1 is incremented and the process returns to step 1809 (step 1812).

Then, from the n-th row record of the conversion rule definition 102, the value of the column having the linked characters of the item name 903 of the record acquired in step 1810 and 1 is acquired. When n=0, m=7, and 1=0, “multiply” is acquired from the column “conversion method 0 208-1” of the 0th row record in the conversion rule definition 102 of FIG. 2 (step 1813).

If there is the column in step 1813 and the value is acquired, the process proceeds to step 1815; if there is no column as the object, the process advances to step 1821. For example, when m=7, i=0, and 1=0, there is the column “conversion method 0 208-1” in the conversion rule definition 102 and the value can be acquired in step 1813, so that the process advances to step 1815.

When m=7, i=0, and 1=2, there is no column of “conversion method 2083” in the conversion rule definition 102, so that the process advances to step 1821 (step 1814).

If the value of the binary table name of the conversion rule binary configuration table 802 acquired in step 1803 or step 1810 is null, the process proceeds to step 1816. If a value other than null is stored in the binary table name, the process advances to step 1817 so as to perform conversion by the binary table (step 1815).

The value acquired in step 1807 or step 1813 that has been stored in the conversion rule definition 102 is post-linked to the conversion rule binary 123 (step 1816).

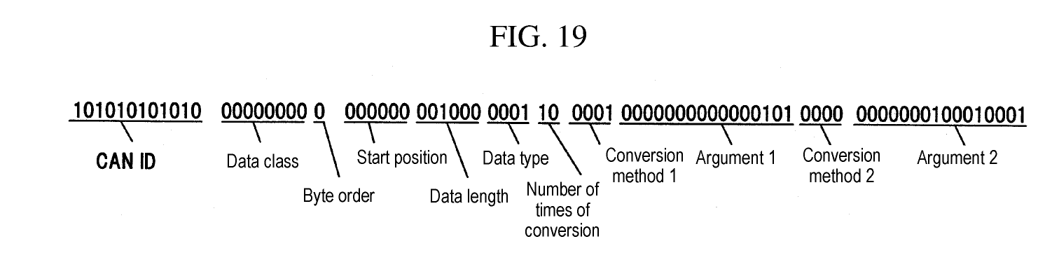

An example of the conversion rule binary 123 is illustrated in FIG. 19.

The “CAN ID 201”, “data class 202”, “byte order bit string 1101”, “start position 204”, “data length 205”, “data type 206”, “number of times of conversion 207”, “conversion method 0 208-1”, “argument 0 209-1”, “conversion method 1 208-2”, and “argument 1 209-2” described in the conversion rule definition 102 are converted into bit strings and linked.

The example of FIG. 19 is the conversion of the first row of the conversion rule definition 102, wherein the CAN ID 201 “AAA (a hexadecimal number)” described in the first row of the conversion rule definition 102 is linked to the conversion rule binary 123 as a bit string “1010101010101010”. The data class 202 “engine coolant temperature” is converted into the bit string “0x00” in the data class bit string table 803 of FIG. 10, changed to the data length 904 described in the conversion rule binary configuration table 802, and linked as a bit string “00000000”.

The value acquired in step 1807 or step 1813 that has been stored in the conversion rule definition 102 is converted by the table of the binary table name of the conversion rule binary configuration table 802 acquired in step 1803 or step 1810. For example, when the data class 202 “engine coolant temperature” is acquired from the conversion rule definition 102, the value is converted into the data class bit string 1001 “0x00” corresponding to the “engine coolant temperature” in the data class bit string table 803803 of FIG. 10 (step 1817).

Then, the value converted in step 1817 is post-linked to the conversion rule binary 123, wherein the data length is in accordance with the value of the data length 904 of the conversion rule binary configuration table 802. For example, when the item name 903 is the data class 202, the bit string “0x00” is post-linked to the conversion rule binary 123 as 8 bits “00000000” (step 1818).

If the value of the sub-index 902 of the record acquired in step 1804 is not null, the process advances to step 1820 so as to convert the next sub-index 902 item. If the value of the sub-index 902 of the record acquired in step 1804 is null, the process advances to step 1821 so as to convert the next index 901 item (step 1819).

The variable i is incremented, and the process returns to step 1810 (step 1820).

The variable m is then incremented and the process returns to step 1802 (step 1821).

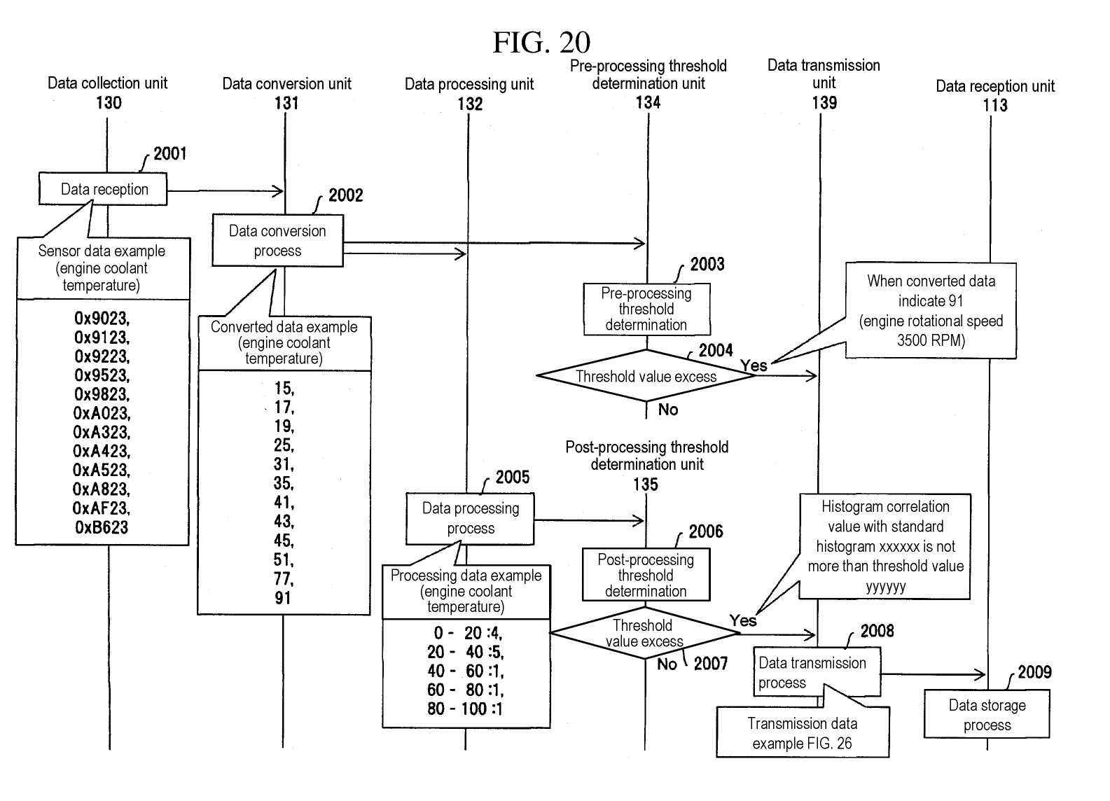

A sequence diagram for describing the sensor data processing/transmission process is illustrated in FIG. 20.

First, the data collection unit 130 receives the data from the sensors 141 and sends the data to the data conversion unit 131 (step 2001).

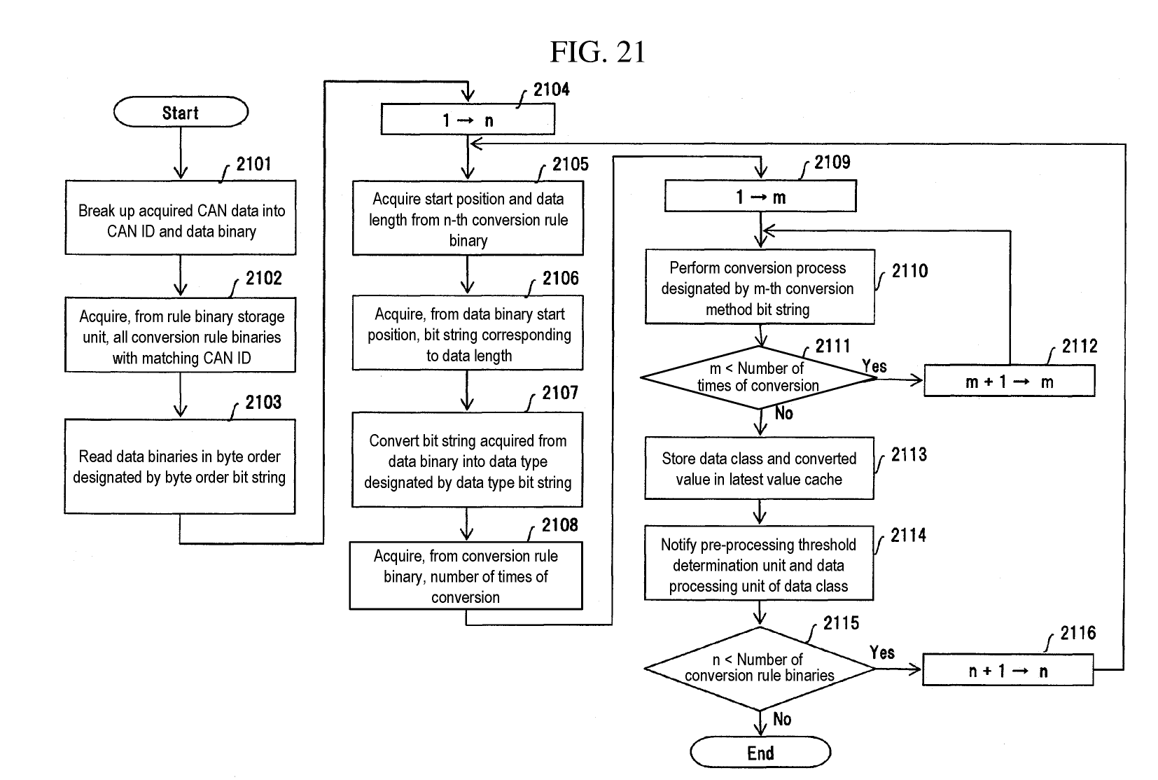

Then, the data conversion unit 131 converts the data received from the data collection unit 130 according to the conversion rule described in the data conversion rule binary 123, stores the converted data in the latest value cache 137, and notifies the pre-processing threshold determination unit 134 and the data processing unit 132 of the item name 903 of the data (step 2002). The details of the data conversion process will be described with reference to FIG. 21.

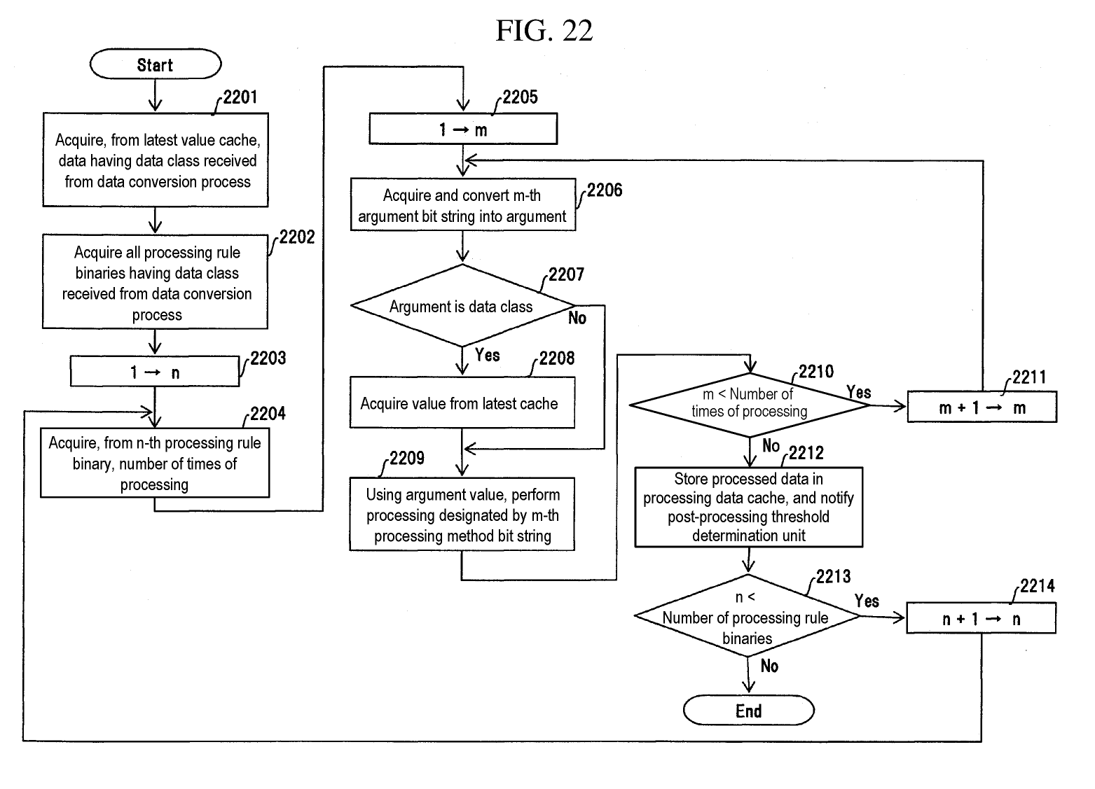

The pre-processing threshold determination unit 134 then acquires from the latest value cache 137 the data of the item name 903 included in the notification received from the data conversion unit 131, and performs threshold determination according to the threshold value rule described in the pre-processing threshold value binary (step 2003). The details of the pre-processing threshold determination process will be described with reference to FIG. 22.

If a threshold value excess is found in step 2003, the data transmission unit 139 is notified of the transmission definition ID 402, and the process proceeds to step 2008. If no threshold value excess is found, the process is ended (step 2004).

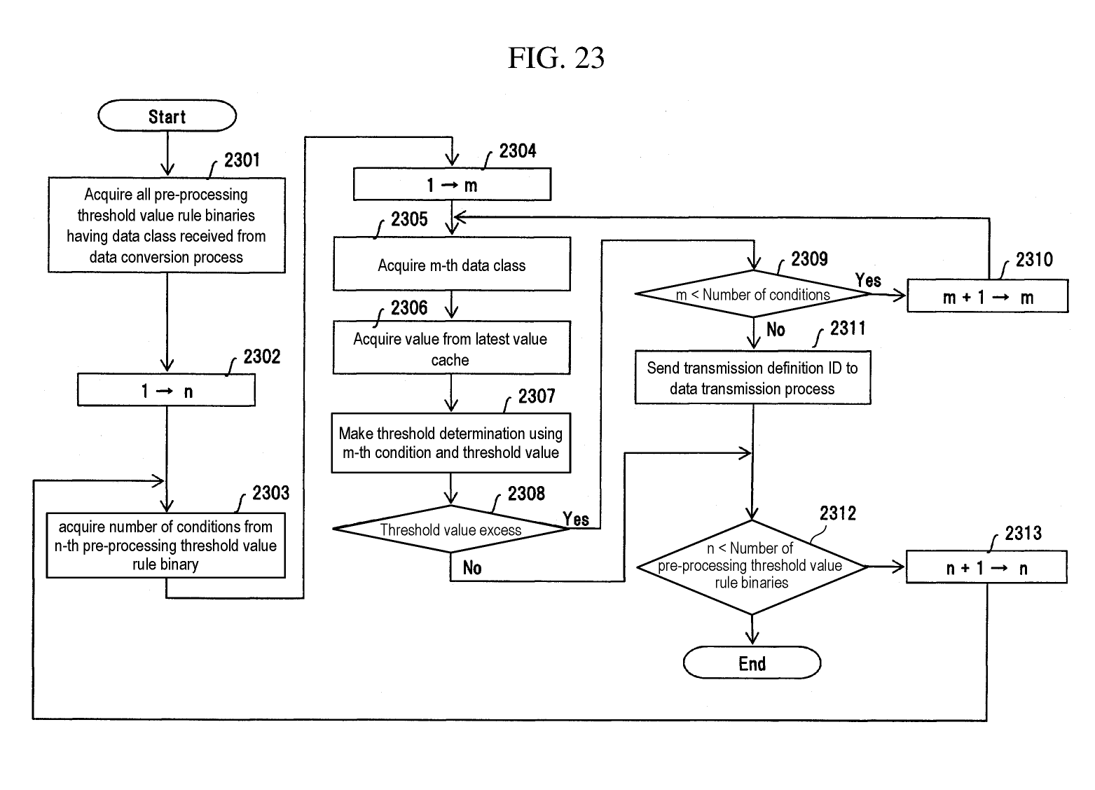

The data processing unit 132 then acquires from the latest value cache 137 the data of the item name 903 included in the notification received from the data conversion unit 131, performs a processing process in accordance with the processing rule described in the processing rule binary 124, stores the processed data in the processing data cache 138, and notifies the post-processing threshold determination unit 135 of the processing data ID 301 of the data (step 2005; the details of the data processing process will be described with reference to FIG. 23).

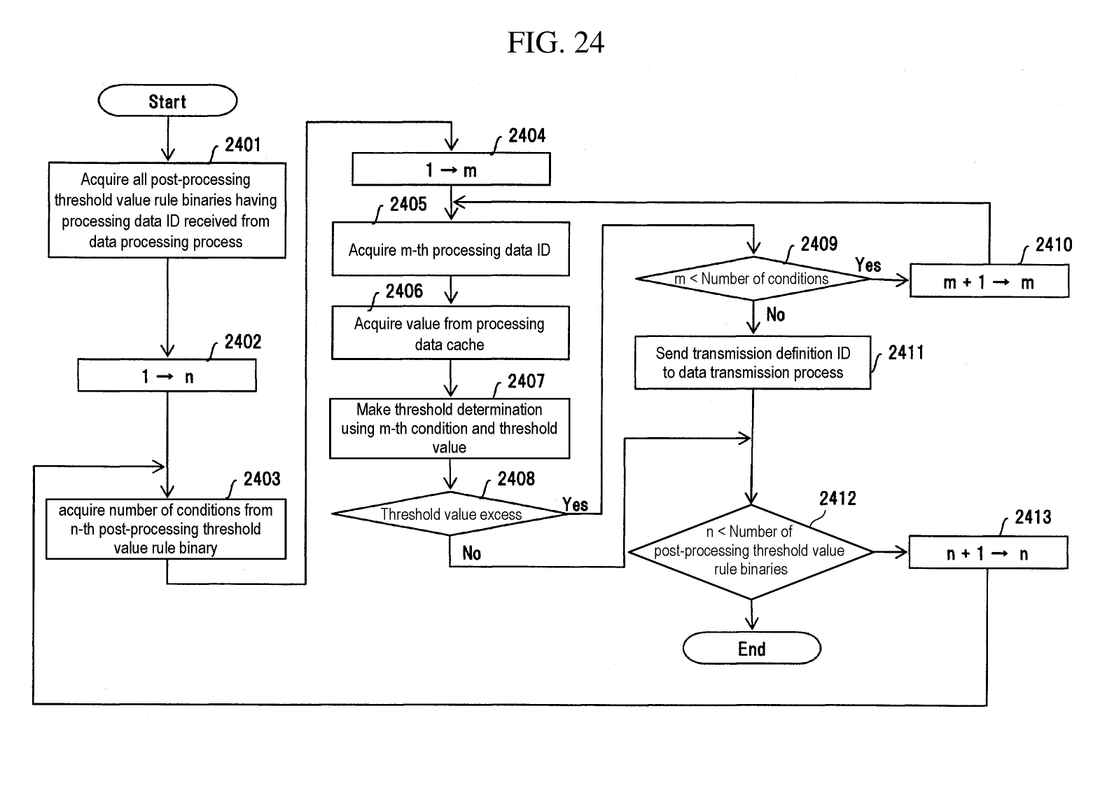

The post-processing threshold determination unit 135 acquires from the processing data cache 138 the data of the processing data ID 301 included in the notification received from the data processing unit 132, and performs threshold determination in accordance with the threshold value rule described in the post-processing threshold value rule binary 126 (step 2006). The details of the post-processing threshold determination process will be described with reference to FIG. 24.

If a threshold value excess is found in step 2006, the data transmission unit 139 is notified of the transmission definition ID 402 and the process proceeds to step 2008. If no threshold value excess is found, the process is ended (step 2007).

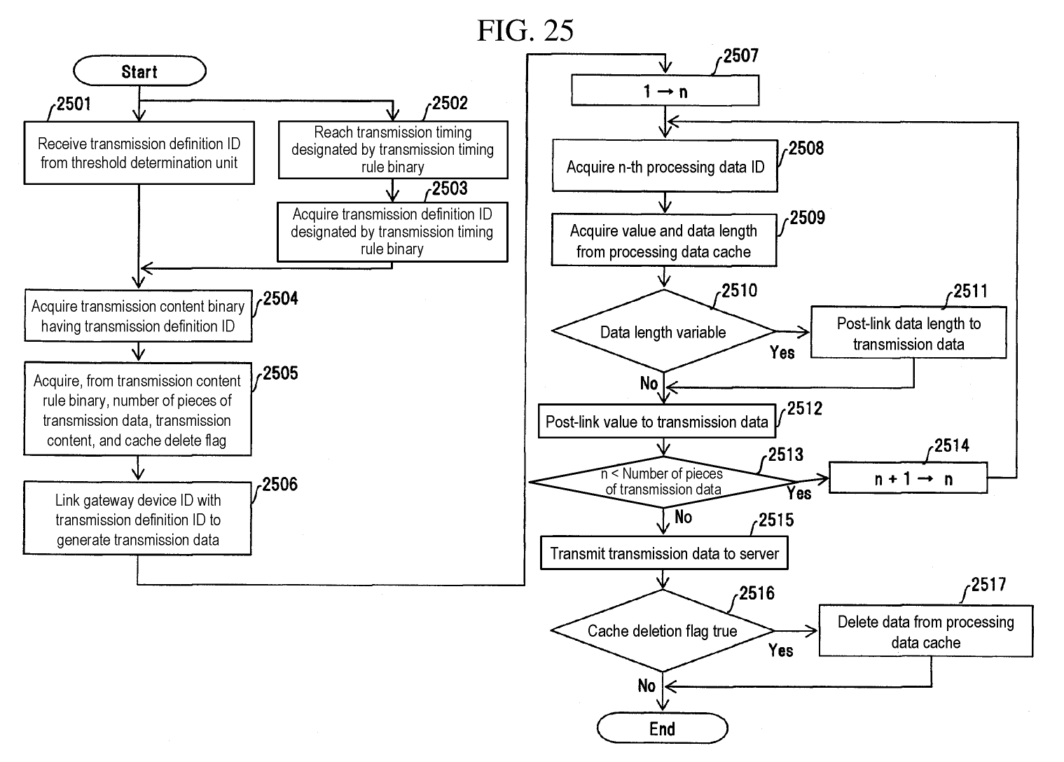

The data transmission unit 139 transmits to the data reception unit 113 the data in accordance with the transmission rule described in the transmission content rule binary 128 corresponding to the transmission definition ID 402 received from the pre-processing threshold determination unit 134 or from the post-processing threshold determination unit 135. The data transmission unit 139 also transmits the data to the data reception unit 113 similarly in accordance with the transmission rule defined by the transmission content rule binary 128 at the transmission timing 601 described in the transmission timing rule binary 127 (step 2008). The details of the data transmission process will be described with reference to FIG. 25.

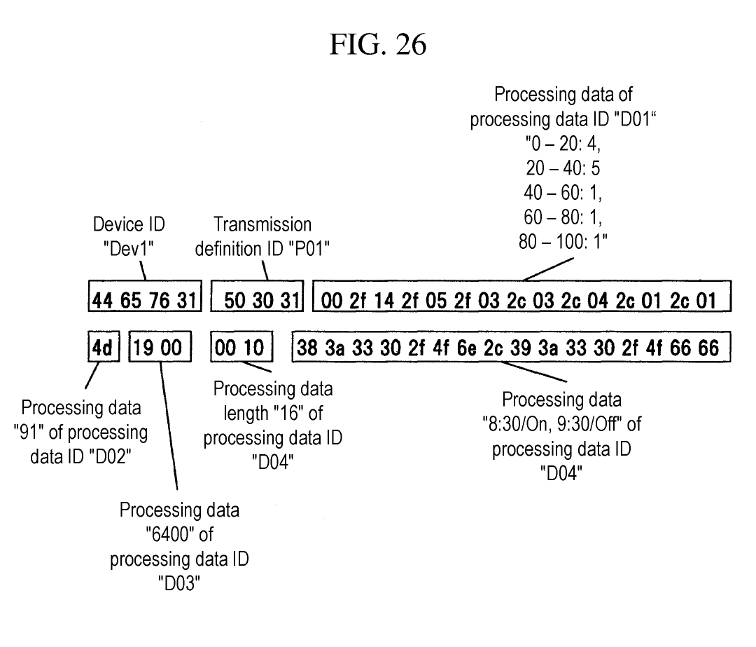

The data reception unit 113 then separates the data received from the data transmission unit 139 in accordance with the rules described in the various rule definitions, and stores the data in the data storage unit 114 (step 2009). The details of the data storage process will be described with reference to FIG. 26.

FIG. 21 shows a flowchart of the data conversion process of step 2002.

First, the CAN data acquired from the data collection unit 130 is broken up into the CAN ID 201 and the data binary (step 2101).

Then, all of the conversion rule binaries 123 corresponding to the CAN ID 201 acquired from the rule binary storage unit 129 in step 2101 are acquired. For example, when the CAN ID 201 is “AAA”, the conversion rule binaries 123 generated from the rule definitions described in the first and second rows of the conversion rule definition 102 are acquired (step 2102).

The data binary is read by the byte order bit string 1101 of the data conversion binaries acquired in step 2102 that are designated by the byte order bit string 1101 bit string. When the CAN ID 201 is “AAA”, the byte order bit string 1101 bit strings are all “1” indicating little-endian, so that the data binary is read as little-endian (step 2103).

Then, 1 is substituted in the variable n, which indicates the order of the conversion rule binary 123 (step 2104).

The start position 204 and the data length 205 are acquired from the n-th conversion rule binary 123. In the case of the conversion rule binary 123 generated from the rule definition of the first row of the conversion rule definition 102 of FIG. 2, “0” is acquired as the start position 204 and “8” is acquired as the data length 205 (step 2105).

The bit string corresponding to the data length 205 is acquired from the start position 204 of the data binary read in step 2103 that has been acquired in step 2105 (step 2106).

The bit string acquired in step 2106 is converted into the data type 206 designated by the data type bit string 1201 of the n-th conversion data binary. In the case of the conversion rule binary 123 generated from the rule definition of the first row of the conversion rule definition 102 of FIG. 2, if the acquired bit string is “00111100”, the bit string is converted into “60” as the data type 206 “int16” (step 2107).

The number of times of conversion 207 is acquired from the n-th conversion rule binary 123. In the case of the conversion rule binary 123 generated from the rule definition of the first row of the conversion rule definition 102 of FIG. 2, the number of times of conversion 207 “2” is acquired (step 2108).

Then, 1 is substituted in the variable m, which indicates the order of conversion and is incremented until the number of times of conversion 207 acquired in step 2108 (step 2109).

With respect to the data of the data type 206 converted in step 2107 or in the present step, the conversion process designated by the m-th conversion method bit string 1301 of the n-th conversion rule binary 123 is performed. In the example of step 2107, with respect to the data “60”, “5” is multiplied when m is 0 and “273” is subtracted when m is 1, obtaining the data “27” (step 2110).

If m is less than the number of times of conversion 207 acquired in step 2108, the process proceeds to step 2112; if not less than the number of times of conversion 207, the process advances to step 2113 (step 2111).

Then, the variable m is incremented and the process returns to step 2110 (step 2112).

The data converted in step 2110 is stored in the latest value cache 137 together with the data class 202 (step 2113).

The pre-processing threshold determination unit 134 and the data processing unit 132 are notified of the data class 202 of the data converted in step 2110 (step 2114).

If n is less than the number of conversion rule binaries 123 acquired in step 2102, the process proceeds to step 2116; if not less than the number of conversion rule binaries 123, the data conversion process is ended (step 2115).

Then, the variable n is incremented and the process returns to step 2105 (step 2116).

FIG. 22 shows a flowchart of the data processing process of step 2005.

First, the data having the data class 202 notified from the data conversion process of FIG. 21 are acquired from the latest value cache 137. If the notified data class 202 is “engine coolant temperature”, “60” is acquired from the latest value cache 137 (step 2201).

Then, all of the processing rule binaries 124 having the data class 202 notified from the data conversion process are acquired. If the data class 202 is “engine coolant temperature”, the processing rule binaries 124 generated from the first and second rows of the processing rule definition 103 of FIG. 3 are acquired (step 2202).

1 is substituted in the variable n, which is incremented by the number of the processing rule binaries 124 acquired in step 2202 (step 2203).

The number of times of processing 303 is acquired from the n-th processing rule binary 124. For example, in the case of the processing rule binary 124 generated from the first row of the processing rule definition 103 of FIG. 3, the number of times of processing 303 “2” is acquired (step 2204).

1 is substituted in the variable m, which is incremented by the number of times of processing 303 acquired in step 2204 (step 2205).

The m-th argument bit string is then acquired from the n-th processing rule binary 124 and converted into an argument value. For example, in the case of the processing rule binary 124 generated from the first row of the processing rule definition 103 of FIG. 3, the “data class 202: outer air temperature” is acquired and converted when m is 0, and “200/0” is acquired and converted when m is 1 (step 2206).

If the argument 305 acquired in step 2206 is the data class 202, the process proceeds to step 2208; if other than the data class 202, the process advances to step 2209 (step 2207).

Then, the value of the data class 202 described in the argument 305 is acquired from the latest value cache 137. For example, when “data class 202: outer air temperature” has been acquired in step 2206, “17” is acquired from the latest value cache 137 of FIG. 14 (step 2208).

With respect to the data acquired in step 2201 or the data processed in the present step, the processing process designated by the m-th processing method bit string of the n-th processing rule binary 124 is performed using the argument value acquired in step 2206 or step 2207. When n=0 and m=0, the processing method 304 is “subtract”. Thus, the outer air temperature “17” acquired in step 2207 is subtracted from the latest value 1401 “60” of the engine coolant temperature, obtaining “43”. Further, when m=1, “43” is added to “histogram” (step 2209).

If m is less than the number of times of processing 303 acquired in step 2204, the process proceeds to step 2211; if not less than the number of times of processing 303, the process advances to step 2212 (step 2210).

Then, m is incremented and the process returns to step 2206 (step 2211).

The data processed in step 2209 are stored in the processing data cache 138, and the post-processing threshold determination unit 135 is notified thereof. If nothing is stored in the data length 302 of the processing data cache 138, the data length 302 of the n-th processing rule binary 124 is stored together (step 2212).

If n is less than the number of the processing rule binaries 124 acquired in step 2202, the process proceeds to step 2214; if not less than the number of the processing rule binaries 124, the data processing process is ended (step 2213).

Finally, n is incremented and the process returns to step 2204 (step 2214).

FIG. 23 shows a flowchart of the pre-processing threshold determination process of step 2003.

First, all of the pre-processing threshold value rule binaries 125 having the data class 202 notified from the data conversion unit 131 are acquired. If the notified data class 202 is “engine coolant temperature”, the pre-processing threshold value rule binary 125 generated from the record in the first row of the pre-processing threshold value rule definition 104 of FIG. 4 is acquired (step 2301).

Then, 1 is substituted in the variable n, which is incremented by the number of the pre-processing threshold value rule binaries 125 (step 2302).

The number of conditions 401 is acquired from the n-th pre-processing threshold value rule binary 125 acquired in step 2301 (step 2303).

Then, 1 is substituted in the variable m, which is incremented by the number of the threshold determination conditions 403. From the pre-processing threshold value rule binary 125 generated from the first row of the pre-processing threshold value rule definition 104 of FIG. 4, “2” is acquired (step 2304).

From the n-th pre-processing threshold value rule binary 125, the m-th data class 202 is acquired. When m=0, “engine coolant temperature” is acquired, and when m=1, “engine rotational speed” is acquired (step 2305).

The value of the data class 202 acquired in step 2305 is acquired from the latest value cache 137. If the data class 202 is “engine coolant temperature”, “60” is acquired from the latest value cache 137 of FIG. 14 (step 2306).

From the n-th pre-processing threshold value rule binary 125, the m-th condition 403 and the threshold value 404 are acquired, and threshold determination is performed (step 2307).

If a threshold value excess is found by the threshold determination of step 2307, the process proceeds to step 2310; if no threshold value excess is found, the process advances to step 2311. In the case of the pre-processing threshold value rule binary 125 generated from the pre-processing threshold value rule definition 104 of FIG. 4, if “engine coolant temperature” is greater than “80”, the process advances to step 2310 (step 2308).

If m is less than the number of conditions 401 acquired in step 2303, the process proceeds to step 230; if not less than the number of conditions 401, the process advances to step 2309 (step 2309).

Then, m is incremented and the process returns to step 2305 (step 2310).

From the n-th pre-processing threshold value rule binary 125, the transmission definition ID 402 is acquired and sent to the data transmission unit 139 (step 2311).

If n is less than the number of the pre-processing threshold value rule binaries 125 acquired in step 2301, the process proceeds to step 2313; if not less than the number of the pre-processing threshold value rule binaries 125, the pre-processing threshold determination process is ended (step 2312).

Finally, n is incremented and the process returns to step 2303 (step 2313).

FIG. 24 shows a flowchart of the post-processing threshold determination process of step 2006.

First, all of the post-processing threshold value rule binaries 126 having the processing data ID 301 notified from the data processing unit 132 are acquired. If the notified processing data ID 301 is “D01”, the post-processing threshold value rule binary 126 generated from the record in the first row of the post-processing threshold value rule definition 105 of FIG. 5 is acquired (step 2401).

Then, 1 is substituted in the variable n, which is incremented by the number of the post-processing threshold value rule binaries 126 (step 2402).

The number of conditions 501 is acquired from the n-th post-processing threshold value rule binary 126 acquired in step 2401 (step 2403).

1 is substituted in the variable m, which is incremented by the number of the threshold determination conditions 502. From post-processing threshold value rule binary 126 generated from the first row of the post-processing threshold value rule definition 105 of FIG. 5, “1” is acquired (step 2404).

The m-th processing data ID 301 is acquired from the n-th post-processing threshold value rule binary 126. When m=0, “D01” is acquired (step 2405).

The value of the processing data ID 301 acquired in step 2405 is acquired from the processing data cache 138 (step 2406).

From the n-th post-processing threshold value rule binary 126, the m-th condition 502, the standard value 503, and the threshold value 504 are acquired, and threshold determination is performed. If the condition 502 is “histogram correlation”, the coefficient of correlation of the histogram in the processing data cache 138 and the histogram stored in the standard value 503 is determined to make a threshold value excess determination (step 2407).

If a threshold value excess is found by the threshold determination in step 2405, the process proceeds to step 2409; if no threshold value excess is found, the process advances to step 2410 (step 2408).

If m is less than the number of conditions 501 acquired in step 2403, the process proceeds to step 2410; if not less than the number of conditions 501, the process advances to step 2411 (step 2409).

Then, m is incremented, and the process returns to step 2405 (step 2410).

From the n-th post-processing threshold value rule binary 126, the transmission definition ID 402 is acquired and sent to the data transmission unit 139 (step 2411).

If n is less than the number of the post-processing threshold value rule binaries 126 acquired in step 2401, the process proceeds to step 2413; if not less than the number of the post-processing threshold value rule binaries 126, the post-processing threshold determination process is ended (step 2412).

Finally, n is incremented, and the process returns to step 2403 (step 2413).

FIG. 25 shows a flowchart of the data transmission process of step 2007.

The trigger for starting the data transmission process is either the reception of the transmission definition ID 402 at the time of the threshold value excess detection by the threshold determination unit 133 (step 2501), or the acquisition of the transmission definition ID 402 from the transmission rule binary upon reaching the transmission timing 601 designated by the transmission timing rule binary 127 (step 2502 or step 2503). In either case, the process of step 2504 and the subsequent steps is the same.

Thus, the transmission content binary having the transmission definition ID 402 acquired in step 2501 or step 2503 is acquired (step 2504).

From the transmission content binary acquired in step 2504, the number of pieces of transmission data 701, the transmission content 702, and the cache delete flag 703 are acquired (step 2505).

The ID of the gateway device 121 and the transmission data are linked to generate transmission data. In the subsequent steps, the processing data 1501 are linked with the device ID1601 (step 2506).

Then, 1 is substituted in the variable n, which is incremented by the number of pieces of data to be transmitted 701 and utilized for the repetition process (step 2507).

From the transmission content 702 acquired in step 2505, the n-th processing data ID 301 is acquired. When the transmission definition ID 402 is “P00” and n=1, the processing data ID 301 “D01” is acquired (step 2508).

Then, the processing data 1501 and the data length 302 for the processing data ID 301 acquired in step 2508 are acquired from the processing data cache 138. If the processing data ID 301 acquired in step 2508 is “D04”, the processing data 1501 “8:30/On, 9:30/Off” and the data length 302 “variable length: 2” can be acquired (step 2509).

If the data length 302 acquired in step 2509 has a variable length, the process proceeds to step 2511; if the data length has a fixed length, the process advances to step 2512 (step 2510).

The data length 302 of the processing data 1501 acquired in step 2509 is calculated, and the data length of the processing data 1501 is post-linked to the transmission data by the number of bytes designated by the data length 302 acquired in step 2509. If the processing data ID 301 acquired in step 2508 is “D04”, the data length of the processing data 1501 is described in 2 bytes. If the processing data 1501 have a data length of 17 bytes, the binary “0x0011” is post-linked to the transmission data as the data length of the processing data 1501 (step 2511).

The processing data 1501 acquired in step 2509 are post-linked to the transmission data (step 2512).

If n is less than the number of pieces of transmission data 701 acquired in step 2505, the process proceeds to step 2514; if not less than the number of pieces of transmission data 701, the process advances to step 2515 (step 2513).

Then, n is incremented and the process returns to step 2508 (step 2514).

The transmission data are transmitted to the data collection server 101. The transmission data with the transmission definition ID 402 “P01” are illustrated in FIG. 26, showing the device ID1601 and the transmission definition ID 402 provided in step 2506 linked with the processing data 1501 of the processing data ID 301 “D01”, “D02”, “D03”, and “D04” designated as the transmission content 702 by the transmission definition ID 402 “P01”. Because the processing data 1501 of the processing data ID 301 “D04” have a variable length, “00 11” indicating the data length is provided before the processing data 1501 (step 2515).

If the cache delete flag 703 acquired in step 2505 is TRUE, the process proceeds to step 2517; if FALSE, the data transmission process is ended (step 2516).

Then, from the processing data cache 138, all of the processing data 1501 of the processing data ID 301 described in the transmission content 702 acquired in step 2505 are deleted (step 2517).

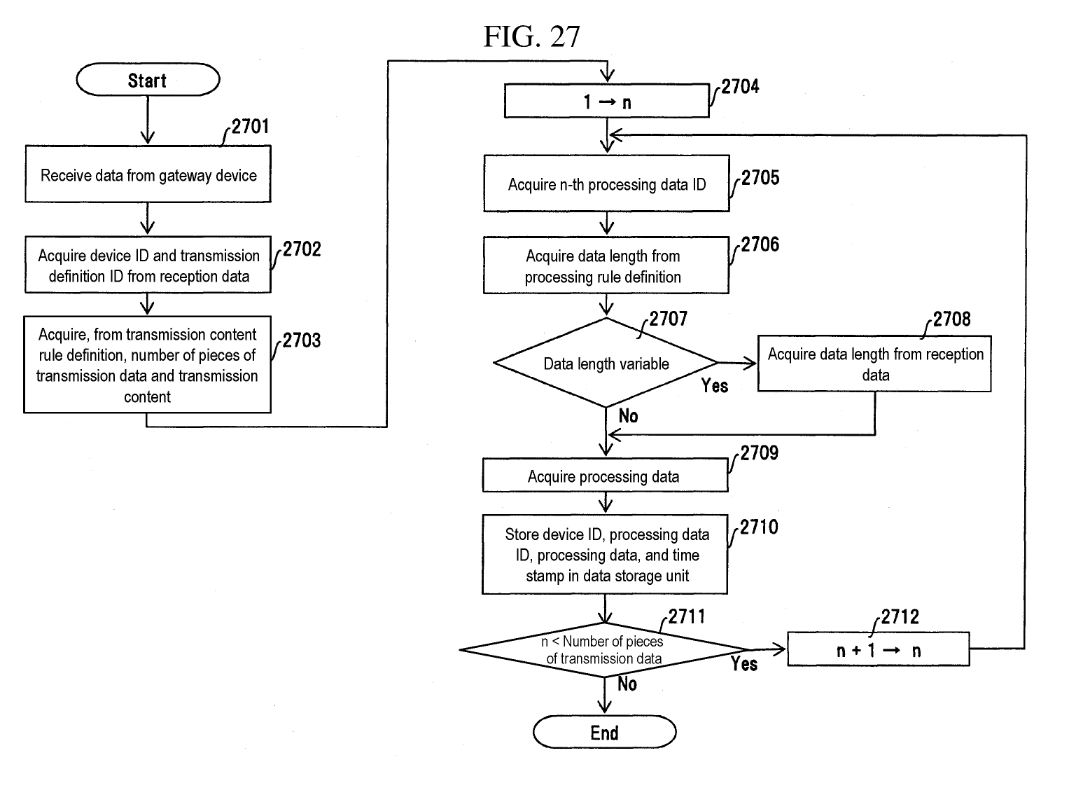

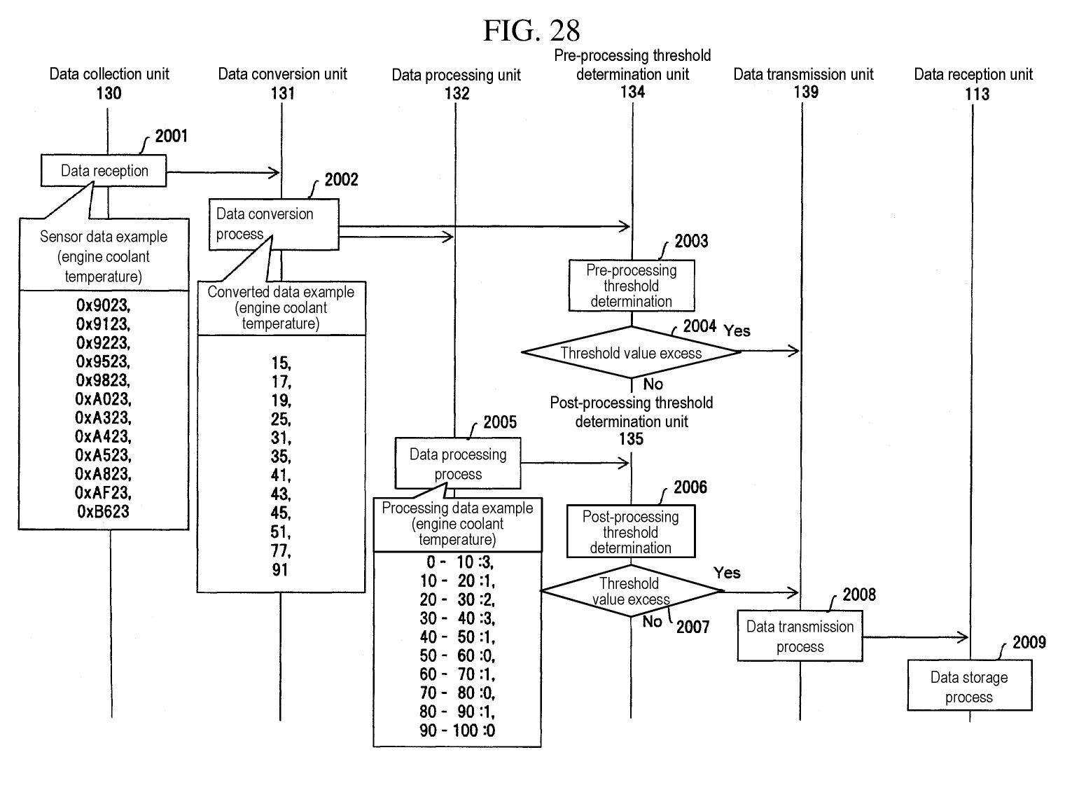

FIG. 27 shows a flowchart of the data storage process of step 2008.

First, data are received from the gateway device 121 (step 2701).

Then, from the data received in step 2701, the device ID1601 and the transmission definition ID 402 are acquired. If the data illustrated in FIG. 26 are received, the device ID 1601 “Dev1” and the transmission definition ID 402 “P01” are acquired (step 2702).

From the transmission content rule definition 107, the number of pieces of transmission data 701 and the transmission content 702 of the record matching the transmission definition ID 402 acquired in step 2702 are acquired. If the transmission definition ID 402 is “P01”, the number of pieces of transmission data 701 “4” and the transmission content 702 “D01 D02 D03 D04” are acquired (step 2703).

Then, 1 is substituted in variable n, which is incremented by the number of pieces of transmission data 701 acquired in step 2703 and utilized for the acquisition of the processing data 1501 from the transmission data and for the process of repeating the storing in the data storage unit 114 (step 2704).

From the transmission content 702 acquired in step 2703, the n-th processing data ID 301 is acquired. If n=1, the processing data ID 301 “D01” is acquired (step 2705).

From the processing rule definition 103, the data length 302 of the record matching the processing data ID 301 acquired in step 2705 is acquired (step 2706).

If the data length acquired in step 2706 is a variable length, the process proceeds to step 2708; if a fixed length, the process advances to step 2709. For example, if the processing data ID 301 acquired in step 2705 is “D04”, the data length is “variable length: 2”. Accordingly, the process proceeds to step 2708. If the processing data ID 301 acquired in step 2705 is “D01”, the data length is “26” and a fixed length, the process advances to step 2709 (step 2707).

Then, the byte string indicating the data length of the processing data 1501 corresponding to the data length acquired in step 2706 is acquired from the reception data, and the data length of the processing data 1501 is determined. For example, if the processing data ID 301 acquired in step 2705 is “D04”, the data length is “variable length: 2”. Accordingly, the 2 bytes of byte string “00 11” are acquired as the data indicating the data length of the processing data 1501, thereby obtaining the data length “17” for the processing data 1501 (step 2708).

The processing data 1501 corresponding to the data length acquired from the reception data in step 2706 or step 2708 are acquired (step 2709).

The device ID1601 acquired in step 2702, the processing data ID 301 acquired in step 2705, the processing data 1501 acquired in step 2709, and the time stamp 1602 at the time of execution of the present step are stored in the data storage unit 114 (step 2710).

If n is less than the number of pieces of transmission data 701 acquired in step 2703, the process proceeds to step 2712; if not less than the transmission data, the data storage process is ended (step 2711).

Finally, n is incremented and the process returns to step 2705 (step 2712).

### REFERENCE SIGNS LIST

101 Data collection server
102 Conversion rule definition
103 Processing rule definition
104 Pre-processing threshold value rule definition
105 Post-processing threshold value rule definition
106 Transmission timing rule definition
107 Transmission content rule definition
108 Rule definition storage unit
109 Rule definition generation unit
110 Rule binary generation unit
111 Binary definition table group
112 Rule definition delivery unit
113 Data reception unit
114 Data storage unit
121 Gateway device
122 Rule definition reception unit
123 Conversion rule binary
124 Processing rule binary
125 Pre-processing threshold value rule binary
126 Post-processing threshold value rule binary
127 Transmission timing rule binary
128 Transmission content rule binary
129 Rule binary storage unit
130 Data collection unit
131 Data conversion unit
132 Data processing unit
133 Threshold determination unit
134 Pre-processing threshold determination unit
135 Post-processing threshold determination unit
136 Data cache
137 Latest value 1401 cache
138 Processing data cache
139 Data transmission unit
141 Sensor
151 Wide area network
801 Conversion rule binary definition table group
802 Conversion rule binary configuration table
803 Data class bit string table
804 Byte order bit string table
805 Conversion method bit string table
811 Processing rule binary definition table group
821 Pre-processing threshold determination rule binary definition table group
831 Post-processing threshold determination rule binary definition table group
841 Transmission content rule binary definition table group
851 Transmission timing rule binary definition table group

1. A sensor data collection system comprising:
one or a plurality of sensors;
a gateway device capable of collecting sensor data from the sensors,
converting the sensor data, processing the sensor data, making a threshold determination of the sensor data, compressing the sensor data, and transmitting the sensor data to a data collection server at a timing set as needed; and
the data collection server that collects the sensor data from the gateway device,
wherein the data collection server includes a means that compresses, into a binary, a configuration for conversion of sensor data, a configuration for processing of sensor data, a configuration for threshold determination of sensor data, a configuration for compression of sensor data, and a configuration for transmission timing of sensor data, and that transmits the binary to the gateway device,
and wherein the gateway device includes a means that executes conversion, processing, threshold determination, and compression with respect to the sensor data collected from the sensors in accordance with the configurations compressed into the binary, and that transmits the sensor data to the data collection server at the configured transmission timing.

2. The sensor data collection system according to claim 1,
wherein the data collection server includes a means that generates a rule definition defining the configuration for conversion of sensor data, defining the configuration for processing of sensor data, defining the configuration for threshold determination of sensor data, defining the configuration for compression of sensor data, and defining the configuration for transmission timing of sensor data, and that transmits the rule definition to the gateway device via a wide area network,
and wherein the gateway device includes a means that executes conversion of sensor data, processing of sensor data, threshold determination of sensor data, and compression of sensor data in accordance with the rule definition received from the data collection server, and that transmits the sensor data to the data collection server at the transmission timing.

3. The sensor data collection system according to claim 2,
wherein the data collection server includes a means that converts the rule definition into a definition rule binary with a smaller data size, and a means that transmits the definition rule binary to the gateway device via the wide area network,
and wherein the gateway device includes a means that executes conversion of sensor data, processing of sensor data, threshold determination of sensor data, and compression of sensor data in accordance with the rule definition binary, and that transmits the sensor data to the data collection server at the transmission timing.
